(19) United States
(12) Patent Application Publication
(10) Pub. No.: US 2025/0210996 A1
(43) Pub. Date: Jun. 26, 2025

(54) POWER GRID REAL-TIME SCHEDULING OPTIMIZATION METHOD AND SYSTEM, COMPUTER DEVICE AND STORAGE MEDIUM

(71) Applicant: CHINA ELECTRIC POWER RESEARCH INSTITUTE, Beijing (CN)

(72) Inventors: Nan YANG, Beijing (CN); Yupeng HUANG, Beijing (CN); Lixin LI, Beijing (CN); Jinbo LIU, Beijing (CN); Yijun YU, Beijing (CN); Xuri SONG, Beijing (CN); Yadi LUO, Beijing (CN); Li LI, Beijing (CN); Xiaolin QI, Beijing (CN); Yi HAN, Beijing (CN); Chengjian QIU, Beijing (CN); Fengbin ZHANG, Beijing (CN); Xingwei LIU, Beijing (CN); Lei TAO, Beijing (CN); Fangchun DI, Beijing (CN); Sheng LIU, Beijing (CN); Deyue MEN, Beijing (CN); Zechen WEI, Beijing (CN)

(21) Appl. No.: 18/846,402

(22) PCT Filed: Jul. 19, 2023
(86) PCT No.: PCT/CN2023/108153

§ 371 Date: Sep. 12, 2024

(30) Foreign Application Priority Data
Jul. 26, 2022 (CN) 202210886335.2

(51) Int. Cl. H02J 3/46; H02J 3/32

(52) U.S. Cl. CPC H02J 3/46; H02J 3/32; H02J 3/466; H02J 2203/10; H02J 2203/20; H02J 2300/24; H02J 2300/40

(57) ABSTRACT

Disclosed in the present application are a power grid real-time scheduling optimization method and system, a computer device and a storage medium. The method comprises: acquiring power grid model parameters and power grid operation data; and according to the power grid model parameters and the power grid operation data, obtaining a power grid real-time scheduling adjustment strategy by means of a preset power grid real-time scheduling reinforcement learning training model. Massive operation data of a power grid and load flow calculation simulation technologies can be fused by means of reinforcement learning, and unlike a conventional algorithm, a complex and difficult-to-solve calculation model does not need to be established, so that rapid optimization adjustment of power grid real-time scheduling is achieved, the optimization adjustment cost is reduced, and the matching degree of power grid real-time scheduling and actual operation is improved. The problem of real-time scheduling optimization of a power grid is solved, and the defects of difficulty in modeling in consideration of uncertain factors and slow calculation for solving large-scale optimization in existing algorithms due to the characteristics of strong uncertainty, rapidly increasing control scale and the like of novel power systems are overcome.

### CROSS-REFERENCE TO RELATED APPLICATION

The present application is a national stage of International Application No. PCT/CN2023/108153, filed on Jul. 19, 2023, which is based on and claims the benefit of priority of the Chinese Patent Application No. 202210886335.2, filed on Jul. 26, 2022. International Application No. PCT/CN2023/108153 and Chinese Patent Application No. 202210886335.2 are incorporated by reference herein in their entireties.

### TECHNICAL FIELD

The disclosure relates to the field of power automation, in particular to a method and system for power grid real-time dispatch optimization, a computer device and a storage medium.

### BACKGROUND

The power system is a real-time balance system of power generation and power consumption, which requires dispatchers to conduct real-time dispatch operations according to the operation of the power grid to ensure the safe operation of the power grid. Due to the strong real-time performance, dispatchers usually adjust dispatch operations based on experience or real-time dispatch optimization results. At present, real-time dispatch optimization and adjustment aim to ensure the real-time power balance of the power grid by utilizing energy and device reasonably with the lowest power generation cost or fuel cost under the premise of meeting safety and power quality. It is essentially a multi-objective optimization problem with multiple constraints. With the transformation and upgrading of traditional power systems to new power systems, the control scale of the power grid is growing exponentially, the characteristics of the control objects are of great difference, and the uncertainty of both source and load is increasing. Real-time dispatch optimization and adjustment will present complex characteristics of high dimension, nonlinearity and non-convexity, such that real-time dispatch will face severe challenges.

At present, the intelligent algorithms that have been applied in real-time dispatch optimization and adjustment include genetic algorithms and particle swarm optimization algorithms and so on. For example, the Chinese Patent Application CN105046395A discloses an intraday rolling scheduling method of an electric power system including multiple types of new energy. The method includes the following steps of: (1) determining constrained conditions, optimization objects and corresponding algorithm options according to scheduling demands; (2) setting up an intraday rolling model based on robust scheduling, and solving the scheduling model using the original dual interior point algorithm or other nonlinear programming algorithms; (3) adopting the static security correction service of an electric power system robust scheduling system with multiple time scales to achieve static security correction of a robust scheduling intraday plan; and (4) adopting the electric power system robust scheduling system with multiple time scales to issue the securely corrected rolling scheduling plan to an energy managing system in a file means or in an automatic way.

However, whether it is genetic algorithm, particle swarm optimization algorithm, or the intelligent algorithm referred to in the above-mentioned patent application, they are all model-driven optimization algorithms in essence. When facing the strong uncertainty, rapidly growing of control scale and the like in new power systems, such algorithms encounters problems such as difficulty in modeling of multiple uncertain factors and slow computation in solving large-scale optimization models, thus, it is difficult for power grid real-time dispatch optimization.

### SUMMARY

The disclosure aims to overcome the shortcomings of the related art above, and provides a method and system for power grid real-time dispatch optimization, a computer device and a storage medium.

To this end, the disclosure adopts the following technical solutions for implementation.

In a first aspect, an embodiment of the disclosure provides a method for power grid real-time dispatch optimization, which includes that: power grid model parameters and power grid operation data are acquired: a power grid real-time dispatch adjustment strategy is obtained through a preset reinforcement learning and training model for power grid real-time dispatch according to the power grid model parameters and the power grid operation data.

Alternatively, the preset reinforcement learning and training model for the power grid real-time dispatch includes an agent and a reinforcement learning and training environment. The operation of obtaining the power grid real-time dispatch adjustment strategy through the preset reinforcement learning and training model for the power grid real-time dispatch, includes that: interaction operations are repeated for a preset number of times. Herein, the interaction operations include that: the reinforcement learning and training environment obtains a state space through a preset power flow simulation function according to the power grid model parameters and the power grid operation data, obtains a reward feedback through a preset reward feedback function according to the state space, and transmits the state space and the reward feedback to the agent: the agent obtains an action strategy according to the state space and the reward feedback and transmits the action strategy to the reinforcement learning and training environment; and the reinforcement learning and training environment verifies the action strategy according to an action space, and updates the power grid operation data by executing the verified action strategy. The action strategy executed when the reward feedback is the highest is taken as the power grid real-time dispatch adjustment strategy.

Alternatively, the state space of the reinforcement learning and training environment includes an active power output of generating units, a reactive power output of the generating units, a voltage magnitude of the generating units, a load active power, a load reactive power, a load voltage magnitude, a charging and discharging power of an energy storage battery, a line status, a line loading rate, a power grid loss, a legal action space at a next time step, a startup-shutdown state of the generating units, a maximum active power output of renewable energy generating units at a current time step, a maximum active power output of the renewable energy generating units at a next time step, a load at a next time step and a power flow convergence flag.

Alternatively, the reward feedback function is a weighted sum of a generation cost of the generating units, a carbon emission cost of the generating units, a loss cost of the energy storage battery, a reserve capacity usage cost, a line loading rate and a degree of node voltage exceeding the limit. Weight coefficients of the generation cost of the generating units, the carbon emission cost of the generating units, the loss cost of the energy storage battery, the reserve capacity usage cost and the degree of node voltage exceeding the limit are negative, and a weight coefficient of the line loading rate is positive.

In some embodiments of the disclosure, when obtaining the power grid real-time dispatch adjustment strategy through the preset reinforcement learning and training model for the power grid real-time dispatch according to the power grid model parameters and the power grid operation data, the method further includes that: equipment failure information of a power grid is acquired, and the power grid model parameters are updated according to the equipment failure information.

In some embodiments of the disclosure, the action space includes respective action variables and action constraints of thermal power units, PV-type renewable energy generating units, PQ-type renewable energy generating units and an energy storage battery. The action variable of the thermal power units includes an active power adjustment amount and a terminal voltage adjustment amount. The action variable of the PV-type renewable energy generating units includes an active power adjustment amount and a terminal voltage adjustment amount. The action variable of the PQ-type renewable energy generating units includes an active power adjustment amount and a reactive power adjustment amount. The action variable of the energy storage battery includes an active power adjustment amount. The action constraint of the thermal power units includes a power output constraint of the generating units, a power output ramping constraint of the generating units, a terminal voltage constraint of the thermal power units and a startup-shutdown constraint of the generating units. The action constraint of the PV-type renewable energy generating units includes a terminal voltage constraint of the renewable energy generating units and a maximum allowable power output constraint of PV-type renewable energy. The action constraint of the PQ-type renewable energy generating units includes a maximum allowable power output constraint of PQ-type renewable energy and a reactive power constraint of the generating units. The action constraint of the energy storage battery includes a battery charging and discharging constraint and a battery capacity constraint.

In some embodiments of the disclosure, the state space also includes a reference value of a day-ahead planned active power output of the generating units.

In a second aspect, an embodiment of the disclosure provides a system for power grid real-time dispatch optimization, which includes a data acquisition module and an optimization processing module.

The data acquisition module is configured to acquire power grid model parameters and power grid operation data. The optimization processing module is configured to obtain a power grid real-time dispatch adjustment strategy through a preset reinforcement learning and training model for power grid real-time dispatch according to the power grid model parameters and the power grid operation data.

Alternatively, the preset reinforcement learning and training model for the power grid real-time dispatch includes an agent and a reinforcement learning and training environment. The optimization processing module is further configured to repeat interaction operations for a preset number of times. The interaction operations include that: the reinforcement learning and training environment obtains a state space through a preset power flow simulation function according to the power grid model parameters and the power grid operation data, obtains a reward feedback through a preset reward feedback function according to the state space, and transmits the state space and the reward feedback to the agent: the agent obtains an action strategy according to the state space and the reward feedback and transmits the action strategy to the reinforcement learning and training environment; and the reinforcement learning and training environment verifies the action strategy according to an action space, and updates the power grid operation data by executing the verified action strategy. The action strategy executed when the reward feedback is the highest is taken as the power grid real-time dispatch adjustment strategy.

Alternatively, the state space of the reinforcement learning and training environment includes an active power output of generating units, a reactive power output of the generating units, a voltage magnitude of the generating units, a load active power, a load reactive power, a load voltage magnitude, a charging and discharging power of an energy storage battery, a line status, a line loading rate, a power grid loss, a legal action space at a next time step, a startup-shutdown state of the generating units, a maximum active power output of renewable energy generating units at a current time step, a maximum active power output of the renewable energy generating units at a next time step, a load at a next time step and a power flow convergence flag.

Alternatively, the reward feedback function is a weighted sum of a generation cost of the generating units, a carbon emission cost of the generating units, a loss cost of the energy storage battery, a reserve capacity usage cost, a line loading rate and a degree of node voltage exceeding the limit. Weight coefficients of the generation cost of the generating units, the carbon emission cost of the generating units, the loss cost of the energy storage battery, the reserve capacity usage cost and the degree of node voltage exceeding the limit are negative, and a weight coefficient of the line loading rate is positive.

In some embodiments of the disclosure, the system further includes a failure setting module configured to acquire equipment failure information of a power grid, and update the power grid model parameters according to the equipment failure information.

In some embodiments of the disclosure, the action space includes respective action variables and action constraints of thermal power units, PV-type renewable energy generating units, PQ-type renewable energy generating units and an energy storage battery. The action variable of the thermal power units includes an active power adjustment amount and a terminal voltage adjustment amount. The action variable of the PV-type renewable energy generating units includes an active power adjustment amount and a terminal voltage adjustment amount. The action variable of the PQ-type renewable energy generating units includes an active power adjustment amount and a reactive power adjustment amount. The action variable of the energy storage battery includes an active power adjustment amount. The action constraint of the thermal power units includes a power output constraint of the generating units, a power output ramping constraint of the generating units, a terminal voltage constraint of the thermal power units and a startup-shutdown constraint of the generating units. The action constraint of the PV-type renewable energy generating units includes a terminal voltage constraint of the renewable energy generating units and a maximum allowable power output constraint of PV-type renewable energy. The action constraint of the PQ-type renewable energy generating units includes a maximum allowable power output constraint of PQ-type renewable energy and a reactive power constraint of the generating units. The action constraint of the energy storage battery includes a battery charging and discharging constraint and a battery capacity constraint.

In some embodiments of the disclosure, the state space also includes a reference value of a day-ahead planned active power output of the generating units.

In a third aspect, an embodiment of the disclosure provides a computer device. The computer device includes a memory, a processor, and computer programs stored in the memory and run on the processor. The processor, when executing the computer programs, implements operations of the method for power grid real-time dispatch optimization described above.

In a fourth aspect, an embodiment of the disclosure provides a computer-readable storage medium storing computer programs. The computer programs, when executed by a processor, implements operations of the method for power grid real-time dispatch optimization described above.

### BRIEF DESCRIPTION OF THE DRAWINGS

FIG. 1 is a flowchart of a method for power grid real-time dispatch optimization according to an embodiment of the disclosure;

FIG. 2 is a schematic diagram of interaction process between an agent and a reinforcement learning and training environment according to an embodiment of the disclosure;

FIG. 3 is a schematic diagram of the agent according to an embodiment of the disclosure;

FIG. 4 is a schematic diagram of the principle of reinforcement learning and training model for the power grid real-time dispatch according to an embodiment of the disclosure;

FIG. 5 is a flowchart of interaction training process between an agent and a reinforcement learning and training environment according to an embodiment of the disclosure; and

FIG. 6 is a structural schematic diagram of a system for power grid real-time dispatch optimization according to an embodiment of the disclosure.

### DETAILED DESCRIPTION

In order for those skilled in the art to better understand the solution of the present disclosure, technical solutions in embodiments of the disclosure will be described clearly and completely below in conjunction with the drawings in the embodiments of the disclosure. It is apparent that the described embodiments are merely part of but not all of the embodiments of the disclosure. All other embodiments obtained by a person of ordinary skill in the art based on the embodiments of the disclosure without paying inventive efforts shall fall within the scope of protection of the disclosure.

It should be noted that the terms “first”, “second” and the like in the Description, the Claims and the above-mentioned Drawings of the disclosure are used to distinguish similar objects, and are not necessarily used to describe a particular order or sequence. It should be understood that the data so used are interchangeable where appropriate, so that the embodiments of the disclosure described herein can be implemented in an order other than those illustrated or described herein. Further, the terms “include” and “have”, and any variations thereof, are intended to cover non-exclusive inclusions. For example, processes, methods, systems, products or devices that containing a series of operations or units need not be limited to those operations or units listed clearly, but may include other operations or units not listed clearly or inherent to such processes, methods, products or devices.

As introduced in the Background, the current optimization problem for power grid real-time dispatch is that, whether it is genetic algorithm, particle swarm optimization algorithm, or other traditional intelligent optimization algorithms, they are all model-driven optimization algorithms in essence. When facing the strong uncertainty, rapid growth of control scale and the like in new power systems, such algorithms encounters problems such as difficulty in modeling of multiple uncertain factors and slow computation in solving large-scale optimization models, thus, it is difficult for power grid real-time dispatch optimization.

In order to improve the above problems, an embodiment of the disclosure provides a method for power grid real-time dispatch optimization, which includes that: power grid model parameters and power grid operation data are acquired; a power grid real-time dispatch adjustment strategy is obtained through a preset reinforcement learning and training model for power grid real-time dispatch according to the power grid model parameters and the power grid operation data. Massive operation data of the power grid and power flow calculation simulation technologies can be fused by adopting reinforcement learning, without the need to establish a complex and difficult-to-solve computation model as a traditional algorithms, so that rapid optimization and adjustment for power grid real-time dispatch can be achieved, the optimization and adjustment cost can be reduced, and the matching degree between power grid real-time dispatch adjustment strategy and actual operation can be improved effectively. It effectively solves the problems in power grid real-time dispatch optimization that due to strong uncertainty and rapidly growing of control scale and the like of new power systems, existing algorithms face difficulties in modeling in consideration of uncertain factors and slow computation for solving large-scale optimization. The following is a further detailed description of the disclosure in conjunction with the drawings.

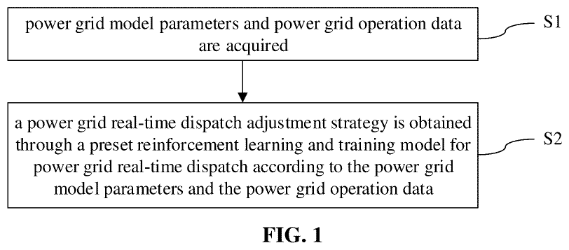

Referring to FIG. 1, in an embodiment of the disclosure, there is provided a method for power grid real-time dispatch optimization, which achieves the power grid real-time dispatch optimization based on reinforcement learning and training, provides new approaches for exploring and realizing the power grid real-time dispatch optimization and adjustment for data-driven based intelligent analysis algorithms, and effectively improves the speed and accuracy of the power grid real-time dispatch optimization.

In some embodiments of the disclosure, the method for power grid real-time dispatch optimization includes the following operations.

In operation S1: power grid model parameters and power grid operation data are acquired.

In operation S2: a power grid real-time dispatch adjustment strategy is obtained through a preset reinforcement learning and training model for power grid real-time dispatch according to the power grid model parameters and the power grid operation data.

In some embodiments of the disclosure, for the problems in power grid real-time dispatch optimization, due to strong uncertainty and rapidly growing of control scale and the like of new power systems, the algorithms face difficulties in modeling in consideration of uncertain factors and slow computation for solving large-scale optimization. However, through the method for power grid real-time dispatch optimization of the disclosure, massive operation data of the power grid and power flow calculation simulation technologies can be fused by adopting reinforcement learning, without the need to establish a complex and difficult-to-solve computation model as a traditional algorithms, so that rapid optimization and adjustment for power grid real-time dispatch can be achieved, the optimization and adjustment cost can be reduced, and the matching degree between power grid real-time dispatch adjustment strategy and actual operation can be improved effectively.

In some embodiments of the disclosure, when obtaining the power grid real-time dispatch adjustment strategy through the preset reinforcement learning and training model for the power grid real-time dispatch according to the power grid model parameters and the power grid operation data, the method further includes that: equipment failure information of a power grid is acquired, and the power grid model parameters are updated according to the equipment failure information.

In some embodiments of the disclosure, for power grid real-time dispatch optimization, it is necessary to fully consider the actual operating conditions of the power grid, and the interruption process or equipment failure of the transmission line caused by prolonged overload may occur in practice. Therefore, when optimizing and adjusting the power grid real-time dispatch, it is necessary to obtain the equipment failure information of the power grid firstly, update the power grid model parameters based on this equipment failure information, modify the basic model of the power grid, and disconnect the relevant branch equipment, so as to ensure the practicability of the optimized power grid real-time dispatch.

In some embodiments of the disclosure, the power grid model parameters can be a text file in xml format, which describes a power grid computation model, mainly including six objects: calculation bus, branch, generating unit, load, direct current line and converter. Before training through the reinforcement learning and training model for power grid real-time dispatch, the power grid model parameters can be modified according to the file format as needed. The model read from the file is called the basic model.

Among them, the calculation bus object mainly includes bus name, type of node, voltage magnitude, voltage phase angle, reference voltage, maximum node voltage and minimum node voltage, etc. The branch object mainly includes serial number of the bus at one end, serial number of the bus at the other end, type of the branch, resistance, reactance, susceptance, final transformation ratio of transformer, phase angle, reference voltage and upper limit of current, etc. The generating unit object includes type of the generating unit, node where the bus is located, given voltage, given phase angle, maximum voltage, minimum voltage, rated capacity, lower limit of active power, upper limit of active power, lower limit of reactive power, upper limit of reactive power, given active power and given reactive power, etc. The load object includes type of node, node where the bus is located, given voltage, given phase angle, given active power, given reactive power, lower limit of active power, upper limit of active power, lower limit of reactive power and upper limit of reactive power, etc. The direct current line object mainly includes serial number of the bus at one end, serial number of the bus at the other end, resistance and rated capacity, etc. The converter object mainly includes converter transformer node, node connected to converter transformer and converter, positive pole node, negative pole node, bus corresponding to positive pole node, logical number of the bus corresponding to negative pole node, alternating current resistance of transformer, alternating current reactance of transformer, tap position of converter transformer, commutation reactance, step-down operating voltage of the converter, converter transformer active power, converter transformer reactive power, direct current power, direct current voltage and current of direct current, etc.

Based on the basic model, it is necessary to read the operating data of the power grid and calculate node injection power according to the bus nodes. The calculation rules are as follows. For PV node: the active power injection power of the node is calculated, which is composed of the generating units (including the energy storage battery) and the load on the node. The node voltage is determined by the generating unit voltage, and there is no need to calculate the reactive power of the node. For PQ node: the active power injection power and reactive power injection power of the node are calculated, which is composed of the generating units (including the energy storage battery) and the load on the node, and there is no need to calculate the node voltage. For slack bus: its node voltage is determined by the voltage on the both ends of the balance generating units, and there is no need to calculate the active power and reactive power of the node. Among them, the PV node is the node with known node injection active power and voltage value, and the PQ node is the node with known node injection active power and node injection reactive power.

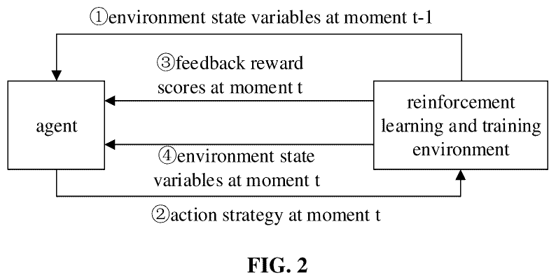

Referring to FIG. 2, the reinforcement learning and training model generally includes an agent and a reinforcement learning and training environment. The general interaction process between the agent and the reinforcement learning and training environment is as follows: the agent obtains the environment state variables of the reinforcement learning and training environment at moment t−1, and then gives the action strategy at moment t. After the reinforcement learning and training environment executes the action strategy at moment t, the reinforcement learning and training environment feeds back the environment state variables and feedback reward scores at moment t to the agent for generating the action strategy at the next moment by the agent.

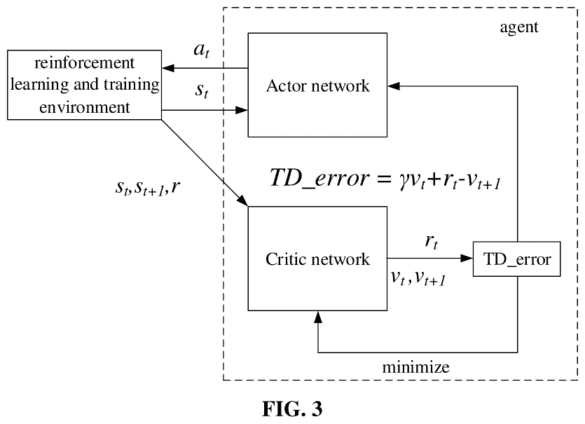

For the reinforcement learning and training model for power grid real-time dispatch, referring to FIG. 3, the agent can be constructed using the current mature Actor-Critic (A-C) architecture. In FIG. 3, at is the real-time dispatch adjustment strategy at moment t, sₜ is the training environment state variable at moment t, sₜ₊₁ is the training environment state variable at moment t+1, and rₜ is the training environment feedback reward score at moment t. TD_error=γVₜ+rₜ−Vₜ₊₁; where, γ is a preset discount factor, and Vₜ₊₁ is the evaluation of real-time dispatch adjustment strategy at moment t+1 by the agent. It includes Actor network and Critic network. According to Markov decision process, Actor is responsible for learning action strategy, and the objective is to maximize the value function to determine the optimal strategy. The objective of Critic is to learn the optimal value function. Generally, the temporal-difference method TD_error is used to enable the agent to interact with the environment to make the loss function smaller.

In some embodiments of the disclosure, the operation of obtaining the power grid real-time dispatch adjustment strategy through the preset reinforcement learning and training model for the power grid real-time dispatch includes that: interaction operations are repeated for a preset number of times. The interaction operations include that: the reinforcement learning and training environment obtains a state space through a preset power flow simulation function according to the power grid model parameters and the power grid operation data, obtains a reward feedback through a preset reward feedback function according to the state space, and transmits the state space and the reward feedback to the agent; the agent obtains an action strategy according to the state space and the reward feedback and transmits the action strategy to the reinforcement learning and training environment; and the reinforcement learning and training environment verifies the action strategy according to an action space, and updates the power grid operation data by executing the verified action strategy. The action strategy executed when the reward feedback is the highest is then taken as the power grid real-time dispatch adjustment strategy.

In some embodiments of the disclosure, the reinforcement learning and training model for power grid real-time dispatch includes an action space, a state space, a power flow simulation function, and a reward feedback function. Among them, the action space is generally designed from three aspects of action object, action variable and action constraint; while the design of the state space needs to fully consider following information: reinforcement learning and training mechanism, electrical characteristics and static parameters of the action object, power grid model parameters and electrical characteristics of power grid equipment, and state variables required by the agent. At the same time, based on the applications of reinforcement learning, the participating adjustment objects in the future power grid real-time dispatch can be transformed from a single conventional energy generating units into multi electrical quantities adjustment of flexible modified generating units, renewable energy, energy storage, pumped storage and other adjustment objects. Therefore, the reinforcement learning and training environment needs to consider a variety of adjustment objects.

In some embodiments of the disclosure, the action space includes action variables and action constraints of thermal power units, PV-type renewable energy generating units, PQ-type renewable energy generating units and an energy storage battery. The action variable of the thermal power units includes an active power adjustment amount and a terminal voltage adjustment amount. The action variable of the PV-type renewable energy generating units includes an active power adjustment amount and a terminal voltage adjustment amount. The action variable of the PQ-type renewable energy generating units includes an active power adjustment amount and a reactive power adjustment amount. The action variable of the energy storage battery includes an active power adjustment amount. The action constraint of the thermal power units includes a power output constraint of the generating units, a power output ramping constraint of the generating units, a terminal voltage constraint of the thermal power units and a startup-shutdown constraint of the generating units. The action constraint of the PV-type renewable energy generating units includes a terminal voltage constraint of the renewable energy generating units and a maximum allowable power output constraint of PV-type renewable energy. The action constraint of the PQ-type renewable energy generating units includes a maximum allowable power output constraint of PQ-type renewable energy and a reactive power constraint of the generating units. The action constraint of the energy storage battery includes a battery charging and discharging constraint and a battery capacity constraint.

In some embodiments of the disclosure, for the thermal power units in the power grid, the thermal power units are generally divided into two categories: one category is the conventional thermal power units, the action variables of which are active power and terminal voltage; and the other category is the thermal power units used for power balance, which are not used for real-time dispatch adjustment, and automatically adjusts the power output according to the unbalanced amount of the power grid. Therefore, the action space of conventional thermal power units is designed, and the expression of the action space of conventional thermal power units at moment t is: aₜ^{thermal}=[ΔP_{1,t}, . . . , ΔP_{I,t}, ΔV_{1,t}, . . . , ΔV_{I,t}.], where, ΔP_{i,t} is the active power adjustment amount of thermal power units, ΔV_{i,t} is the terminal voltage adjustment amount of thermal power units, I is the number of conventional thermal power units, i=1, . . . , I.

For the renewable energy generating units in the power grid, the renewable energy generating units in reinforcement learning and training environment are divided into PV-type renewable energy generating units and PQ-type renewable energy generating units according to the type of node where they are located. The renewable energy generating units located at the PV node is a PV-type renewable energy generating units, and the renewable energy generating units located at the PQ node is a PQ-type renewable energy generating units.

In some embodiments of the disclosure, the action space of the PV-type renewable energy generating units is designed, and the expression of the action space at moment t is:

aₜ^{PV}=[ΔP_{1,t}, . . . ,ΔP_{J,t},ΔV_{1,t}, . . . ,ΔV_{J,t}]

where, ΔP_{j,t} is the active power adjustment amount of the PV-type renewable energy generating units, ΔV_{j,t} is the terminal voltage adjustment amount of the PV-type renewable energy generating units, J is the number of the PV-type renewable energy generating units, j=1, . . . , J. The action space of the PQ-type renewable energy generating units is designed, and the expression of the action space at moment t is: aₜ^{PQ}=[ΔP_{1,t}, . . . , ΔP_{Z,t}, ΔQ_{1,t}, . . . , ΔQ_{Z,t}.], where, ΔP_{z,t} is the active power adjustment amount of the PQ-type renewable energy generating units, ΔQ_{z,t} is the reactive power adjustment amount of the PQ-type renewable energy generating units, Z is the number of the PQ-type renewable energy generating units, z=1, . . . , Z.

For the energy storage battery in the power grid, it is mainly used for peak shaving and valley filling in the power grid, and this effect should also be simulated in reinforcement learning and training environment. The action space of the energy storage battery is designed, and the expression of the action space at moment t is: aₜ^{battery}=[ΔP_{1,t}, . . . , ΔP_{B,t}], where, ΔP_{b,t} is the active power adjustment amount of the energy storage battery, B is the number of the energy storage batteries, b=1, . . . , B.

At the same time, the boundary of the action space is not infinite, and the agent needs to obtain a legal action space from the reinforcement learning and training environment when making decisions, which changes dynamically according to attributes and operating status of the generating units itself.

For the thermal power units, the following action constraints are mainly considered.

Power output constraint of the generating units:

P_{i,t}^{min}≤P_{i,t-1}+ΔP_{i,t}≤P_{i,t}^{max}
where, P_{i,t} is the active power output of the thermal power units i at moment t; ΔP_{i,t} is the active power adjustment amount of the thermal power units i at moment t; P_{i,t}^{min} is the minimum active power output of the thermal power units i at moment t; and P_{i,t}^{max} is the maximum active power output of the thermal power units i at moment t.

Power output ramping constraint of the generating units:

Pᵢ≤ΔP_{i,t}≤P̅ᵢ̅
where, Pᵢ is the ramp-down limit of the thermal power units i; P̅ᵢ̅ is the ramp-up limit of the thermal power units i.

Terminal voltage constraint of the thermal power units:

Vᵢ≤V_{i,t-1}+ΔV_{i,t}≤V̅ᵢ̅
where, Vᵢ is the lower limit of the terminal voltage of the thermal power units i, V̅ᵢ̅ is the upper limit of the terminal voltage of the thermal power units i, V_{i,t-1} is the terminal voltage value of the thermal power units i at moment t−1, ΔV_{i,t} is the terminal voltage adjustment amount of the thermal power units i at moment t.

Startup-shutdown constraint of the generating units: after the thermal power units are put into operation, the thermal power units must continue to operate for a period of time Ti,on before being allowed to shut down. Once the thermal power units are shut down, it must continue to shut down for a period of time Ti,off before being allowed to start up again. Due to the operation characteristics of the thermal power units, the thermal power units need to meet a certain start-up curve and a shut-down curve. Generally, the active power output at start-up must be adjusted to the lower limit of active power output, and the active power output before shutdown must be adjusted to the lower limit of power output, and then adjusted to 0 at the next moment.

In some embodiments of the disclosure, a legal boundary of the active power adjustment amount of the thermal power units is jointly determined by the power output constraint of the generating units, the power output ramping constraint of the generating units and the startup-shutdown constraint of the generating units. The order of being satisfied is to observe firstly whether the normal power output situation is met according to the startup-shutdown constraint of the generating units. If it is met, the intersection of the power output constraint of the generating units and the power output ramping constraint of the generating units is taken as the legal boundary. If not, the startup-shutdown constraint of the generating units is taken as the legal boundary. The legal boundary of terminal voltage adjustment amount of the thermal power units is determined by the terminal voltage constraint of the thermal power units.

Affected by the weather, the legal action space boundary of the renewable energy generating units cannot exceed the maximum power output generated at that time. Among them, for the PV-type renewable energy generating units, the following action constraints are mainly considered.

Terminal voltage constraint of the renewable energy generating units:

Vⱼ≤V_{j,t-1}+ΔV_{j,t}≤V̅ⱼ̅
where, Vⱼ is the lower limit of the terminal voltage of the PV-type renewable energy generating units j, V̅ⱼ̅ is the upper limit of the terminal voltage of the PV-type renewable energy generating units j, V_{j,t-1} is the terminal voltage value of the PV-type renewable energy generating units j at moment t−1, ΔV_{j,t} is the terminal voltage adjustment amount of the PV-type renewable energy generating units j at moment t.

Maximum allowable power output constraint of PV-type renewable energy:

Pⱼ≤P_{j,t-1}+ΔP_{j,t}≤P_{j,t}^{act}
where, Pⱼ is the ramp-down limit of the PV-type renewable energy generating units j, P_{j,t}^{act} is the actual maximum power output of the PV-type renewable energy generating units j at moment t.

The legal boundary of the terminal voltage adjustment amount of the PV-type renewable energy generating units is determined by the terminal voltage constraint of the renewable energy generating units, and the legal boundary of the active power adjustment amount is determined by the maximum allowable power output constraint of PV-type renewable energy.

For the PQ-type renewable energy generating units, the following action constraints are mainly considered.

Maximum allowable power output constraint of PQ-type renewable energy:

P_{z}≤P_{z,t-1}+ΔP_{z,t}≤P_{z,t}^{act}
where, P_{z} is the ramp-down limit of the PQ-type renewable energy generating units z, P_{z,t}^{act} is the actual maximum power output of the PQ-type renewable energy generating units z at moment t.

Reactive power constraint of the generating units:

Q_{z}≤Q_{z,t-1}+ΔQ_{z,t}≤Q̅_̅{̅z̅}̅
where, Q_{z} is the minimum reactive power output of the PQ-type renewable energy generating units z, Q_{z,t-1} is the power output of the PQ-type renewable energy generating units z at moment t−1, ΔQ_{z,t} is the reactive power adjustment amount of the PQ-type renewable energy generating units z, and Q̅_̅{̅z̅}̅ is the maximum reactive power output of the PQ-type renewable energy generating units z.

The legal boundary of the reactive power adjustment amount of the PQ-type renewable energy generating units is determined by the reactive power constraint of the generating units, and the legal boundary of the active power adjustment amount is determined by the maximum allowable power output constraint of PQ-type renewable energy.

For the energy storage battery, the following action constraints are mainly considered.

Battery charging and discharging constraint:

P_{b}^{dis,max}≤P_{b,t}≤P_{b}^{char,max}
where, P_{b}^{dis,max} is the maximum discharging power of the energy storage battery b, and P_{b}^{char,max} is the maximum charging power of the energy storage battery b.

### Battery Capacity Constraint:

0≤ΔP_{b,t}+E_{b,t-1}≤E_{b,max}
where, E_{b,t-1} is the remaining battery capacity of the energy storage battery b at moment t−1, and E_{b,max} is the rated capacity of the energy storage battery b.

Therefore, the legal boundary of the active power adjustment amount of the energy storage battery is determined by the intersection of the battery charging and discharging constraint and the battery capacity constraint.

In some embodiments of the disclosure, the state space of the reinforcement learning and training environment includes an active power output of generating units, a reactive power output of the generating units, a voltage magnitude of the generating units, a load active power, a load reactive power, a load voltage magnitude, a charging and discharging power of an energy storage battery, a line status, a line loading rate, a power grid loss, a legal action space at a next time step, a startup-shutdown state of the generating units, a maximum active power output of renewable energy generating units at a current time step, a maximum active power output of the renewable energy generating units at a next time step, a load at a next time step and a power flow convergence flag.

In some embodiments of the disclosure, in the setting of the state space, the reinforcement learning and training environment takes into comprehensive consideration of the following: reinforcement learning and training mechanism, electrical characteristics and static parameters of the action object, power grid model parameters and electrical characteristics of power grid equipment, and state variables required by the agent. The state space varies with time steps.

In some embodiments of the disclosure, the state space also includes a reference value of a day-ahead planned active power output of the generating units. Specifically, in order to accelerate the training speed of the agent, the reinforcement learning and training environment effectively reduces the search range of the action space by providing the reference value of a day-ahead planned active power output of the generating units.

In some embodiments of the disclosure, the power flow simulation function of the reinforcement learning and training model for power grid real-time dispatch may employ the Newton-Raphson method. When performing power flow calculations by using the Newton-Raphson method, the unbalanced power is fully borne by the balanced generator. If the electrical island is disconnected or the power flow does not converge, the environment will be suspended.

In some embodiments of the disclosure, the reward feedback function is the crucial factor that affects the learning and training effect of the agent. In the implementation, the reward feedback function takes into comprehensive consideration of the following: a generation cost of the generating units, a carbon emission cost of the generating units, a loss cost of the energy storage battery, a reserve capacity usage cost and some safe operation reward feedbacks. Specifically, the reward feedback function is a weighted sum of a generation cost of the generating units, a carbon emission cost of the generating units, a loss cost of the energy storage battery, a reserve capacity usage cost, a line loading rate and a degree of node voltage exceeding the limit. Weight coefficients of the generation cost of the generating units, the carbon emission cost of the generating units, the loss cost of the energy storage battery, the reserve capacity usage cost and the degree of node voltage exceeding the limit are negative, and a weight coefficient of the line loading rate is positive.

Among them, the generation cost of the generating units is modeled by a quadratic curve, and the generation cost of the generating units at moment t is as follows:

$${r}_{1} ( {P}_{ix , t} ) = {\sum }_{ix = 1}^{I + N + Z + J} ( {a}_{ix} {P}_{ix , t}^{2} + {b}_{ix} {P}_{ix , t} + {c}_{ix} )$$

where, P_{i,t} is the power output of the generating units ix at moment t, aᵢₓ is the quadratic term coefficient of the generation cost of the generating units ix, bᵢₓ is the linear term coefficient of the generation cost of the generating units ix, and cᵢₓ is the constant term coefficient of the generation cost of the generating units ix.

In the carbon emission cost of the generating units, the thermal power units are the main source of carbon emissions. Generally, the carbon emission cost of the generating units is modeled by a quadratic curve, and the carbon emission cost of the thermal power units i at moment t is as follows:

$$c ( {P}_{i , t} ) = {α}_{i} {P}_{i , t}^{2} + {β}_{i} {P}_{i , t} + {γ}_{i}$$

Since the renewable energy generating units have almost no carbon emissions, the carbon emission cost of the generating units is as follows:

$${r}_{2} ( {P}_{i , t} ) = {\sum }_{i = 1}^{I} ( {α}_{i} {P}_{i , t}^{2} + {β}_{i} {P}_{i , t} + {γ}_{i} )$$

where αᵢ is the quadratic term coefficient of the carbon emission cost of the thermal power units i, βᵢ is the linear term coefficient of the carbon emission cost of the thermal power units i, and γᵢ is the constant term coefficient of the carbon emission cost of the thermal power units i.

In the loss cost of the energy storage battery, the charging and discharging of the energy storage battery will affect its life. Generally, the loss of the energy storage battery is modeled by a quadratic curve, and the loss cost of the energy storage battery is as follows:

$${r}_{3} ( {P}_{s , t} ) = {\sum }_{s = 1}^{S} ( {λ}_{s} {P}_{s , i}^{2} + {η}_{s} )$$

where λₛ is the quadratic term coefficient of the loss cost of the energy storage battery s, and ηₛ is the constant term coefficient of the loss cost of the energy storage battery s.

In a training environment, the system unbalanced power allocation is performed by balancing generating units, the reserve capacity is used once the allowable limit for the operation of the balancing generating units is exceeded. The reserve capacity usage cost is as follows.

$${r}_{4} ( {P}_{n , t} ) = \{ \begin{matrix}{\sum }_{n = 1}^{N} {e}^{\vert {P}_{n , t} - {P}_{n}^{max} \vert} , {P}_{n , t} > {P}_{n}^{max} \\ 0 , {P}_{n}^{min} \leq {P}_{n , t} \leq {P}_{n}^{max} \\ {\sum }_{n = 1}^{N} {e}^{\vert {P}_{n , t} - {P}_{n}^{min} \vert} , {P}_{n , t} < {P}_{n}^{min}\end{matrix}$$

where, P_{n,t} is the power output of the balancing generating units n at moment k, Pₙ^{max} is the maximum power output of the balancing generating units n, and Pₙ^{min} is the minimum power output of the balancing generating units n.

The line loading rate is as follows.

$${r}_{5} ( {I}_{jx , t} ) = 1 - \frac{1}{J x} {\sum }_{j x = 1}^{Jx} min ( \frac{{I}_{jx , t}}{{l}_{max , jx} + ε} , 1 )$$

where, I_{jx,t} is the current value of branch jx at moment t, which is calculated by the power flow of the power grid environment, I_{max,jx} is the thermal stability limit of the branch jx, Jx is the number of branches, and ε is the minimal constant so as to avoid the situation where the denominator is zero.

The degree of node voltage exceeding the limit is as follows:

$${r}_{6} ( {V}_{g , t} ) = \{ \begin{matrix}{\sum }_{g = 1}^{G} {e}^{\vert {V}_{g , t} - {\overline{V}}_{g} \vert} , {V}_{g , t} > \overline{{V}_{g}} \\ 0 , \underline{{V}_{g}} \leq {V}_{g , t} \leq \overline{{V}_{g}} \\ {\sum }_{g = 1}^{G} {e}^{\vert {V}_{g , t} - \underline{{V}_{g}} \vert} , {V}_{g , t} < \underline{{V}_{g}}\end{matrix}$$

where, G is the number of nodes of the power grid, V_{g,t} is the voltage value of node g, V̅_̅{̅g̅}̅ is the upper voltage limit of node g, and V_{g} is the lower voltage limit of node g.

Thus, the reward feedback score Rₜ at moment t is as follows:

$${R}_{t} = - {w}_{1} {r}_{1} ( {P}_{i , t} ) - {w}_{2} {r}_{2} ( {P}_{i , t} ) - {w}_{3} {r}_{3} ( {P}_{s , t} ) - {w}_{4} {r}_{4} ( {P}_{n , t} ) + {w}_{5} {r}_{5} ( {I}_{j , t} ) - {w}_{6} {r}_{6} ( {V}_{g , t} )$$

where, wᵢ (i=1, . . . , 6) are reward weight coefficients.

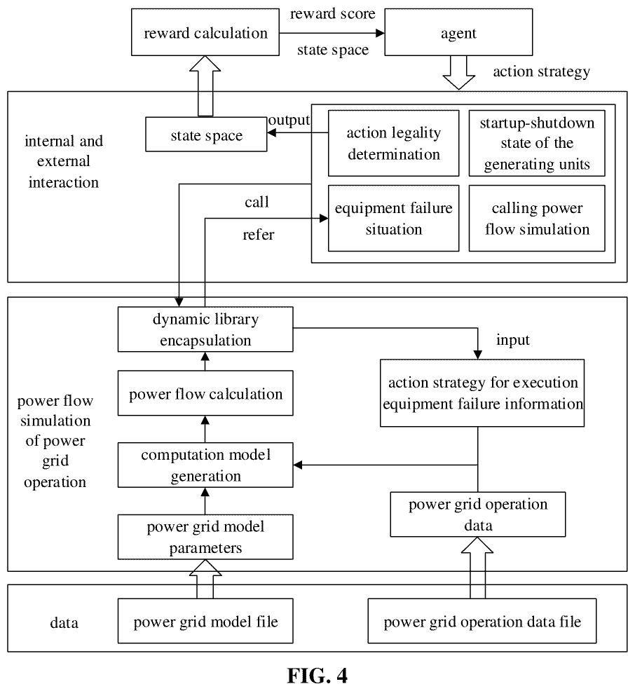

In some embodiments of the disclosure, referring to FIG. 4, in the reinforcement learning and training model for power grid real-time dispatch, the agent gives an action strategy based on the state space and the reward feedback. First, a computation model is constructed based on the acquired power grid model parameters; then the acquired power grid operation data is loaded; the legality of the action strategy is determined according to the action variables and the action constraints; the equipment failure situations are set; the power flow simulation dynamic library is referenced, the power flow simulation function is called; after the power flow simulation function calculation is executed, the state space is returned; and the reward score is calculated and then passed to the agent. Among them, the called functions and variables can be encapsulated through pybind11 to generate a dynamic library for python to call, that is, the power flow simulation dynamic library.

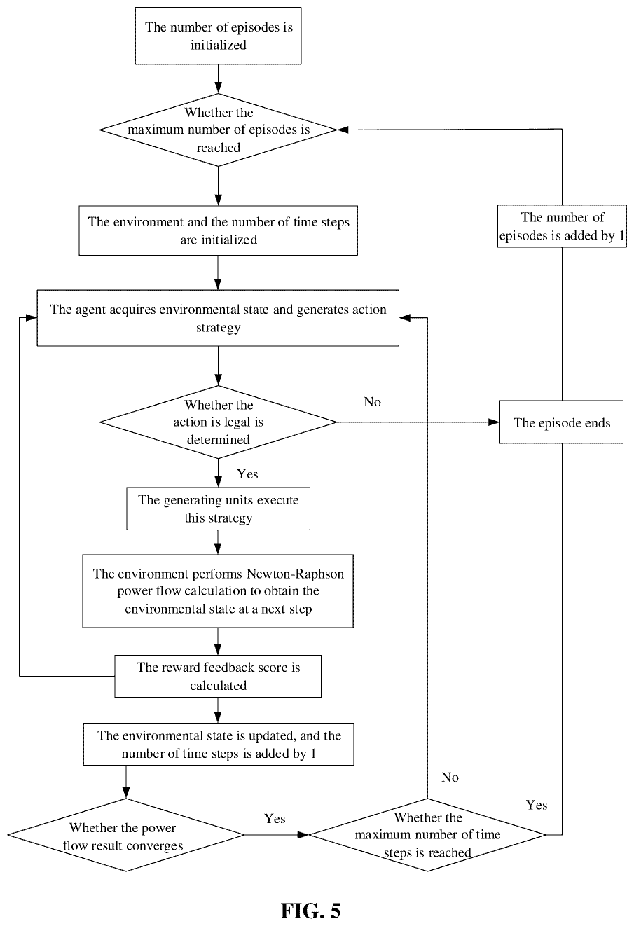

In some embodiments of the disclosure, since the agent training of reinforcement learning and training model for power grid real-time dispatch which is based on reinforcement learning requires interactive training with reinforcement learning and training environment in the episodic manner, that is, the feedback is ended after interacting with the reinforcement learning and training environment for a certain number of operations. Considering that the requirements for agent training are different, the number of interactions per episode and the number of training episodes are also different; referring to FIG. 5, the interaction training process is as follows:
Operation 1: the number of episodes is initialized.
Operation 2: whether the maximum number of episodes is reached is determined. If the maximum number of episodes is not reached, operation 3 is entered. If the maximum number of episodes is reached, the interactive training process ends.
Operation 3: the reinforcement learning and training environment and the number of time steps are initialized.
Operation 4: the agent acquires environmental state and reward feedback score of the reinforcement learning and training environment, and generates action strategy based on the environmental state and the reward feedback score of the reinforcement learning and training environment.
Operation 5: whether the action strategy is legal is determined. When the action strategy is legal, operation 6 is entered. When the action strategy is illegal, the interactive training of this episode ends, and the number of episodes is added by 1 and operation 2 is returned.
Operation 6: the reinforcement learning and training environment executes the action strategy.
Operation 7: the reinforcement learning and training environment performs Newton-Raphson power flow calculation to obtain the environmental state of the reinforcement learning and training environment at a next time step.
Operation 8: the reward feedback score is calculated through the reward feedback function and fed back to operation 4.
Operation 9: the environmental state of the reinforcement learning and training environment is updated, and the number of time steps at this episode is added by 1.
Operation 10: whether the power flow result of the reinforcement learning and training environment converges is determined. If the power flow result converges, whether the maximum number of time steps at this episode is reached is determined. If the maximum number of time steps at this episode is reached, then the interactive training of this episode ends, the number of episodes is added by 1 and returns to operation 2; otherwise, operation 4 is returned. If the power flow result does not converge, the interactive training process ends.

The following is the device embodiment of the disclosure, which may be configured to execute the method embodiment of the disclosure. For details not disclosed in the device embodiment, reference is made to the method embodiment of the disclosure.

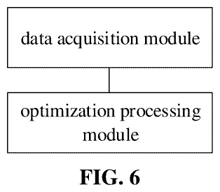

Referring to FIG. 6, in yet another embodiment of the disclosure, there is provided a system for power grid real-time dispatch optimization, which can be used to implement the method for power grid real-time dispatch optimization described above. The system for power grid real-time dispatch optimization includes a data acquisition module and an optimization processing module. The data acquisition module is configured to acquire power grid model parameters and power grid operation data. The optimization processing module is configured to obtain a power grid real-time dispatch adjustment strategy through a preset reinforcement learning and training model for power grid real-time dispatch according to the power grid model parameters and the power grid operation data.

In some embodiments of the disclosure, the system further includes a failure setting module configured to acquire equipment failure information of a power grid and updates the power grid model parameters according to the equipment failure information.

In some embodiments of the disclosure, the preset reinforcement learning and training model for the power grid real-time dispatch includes an agent and a reinforcement learning and training environment. The optimization processing module is further configured to repeat interaction operations for a preset number of times. The interaction operations include that: the reinforcement learning and training environment obtains a state space through a preset power flow simulation function according to the power grid model parameters and the power grid operation data, obtains a reward feedback through a preset reward feedback function according to the state space, and transmits the state space and the reward feedback to the agent; the agent obtains an action strategy according to the state space and the reward feedback and transmits the action strategy to the reinforcement learning and training environment; and the reinforcement learning and training environment verifies the action strategy according to an action space, and updates the power grid operation data by executing the verified action strategy. The action strategy executed when the reward feedback is the highest is taken as the power grid real-time dispatch adjustment strategy.

In some embodiments of the disclosure, the action space includes respective action variables and action constraints of thermal power units, PV-type renewable energy generating units, PQ-type renewable energy generating units and an energy storage battery. The action variable of the thermal power units includes an active power adjustment amount and a terminal voltage adjustment amount. The action variable of the PV-type renewable energy generating units includes an active power adjustment amount and a terminal voltage adjustment amount. The action variable of the PQ-type renewable energy generating units includes an active power adjustment amount and a reactive power adjustment amount. The action variable of the energy storage battery includes an active power adjustment amount. The action constraint of the thermal power units includes a power output constraint of the generating units, a power output ramping constraint of the generating units, a terminal voltage constraint of the thermal power units and a startup-shutdown constraint of the generating units. The action constraint of the PV-type renewable energy generating units includes a terminal voltage constraint of the renewable energy generating units and a maximum allowable power output constraint of PV-type renewable energy. The action constraint of the PQ-type renewable energy generating units includes a maximum allowable power output constraint of PQ-type renewable energy and a reactive power constraint of the generating units. The action constraint of the energy storage battery includes a battery charging and discharging constraint and a battery capacity constraint.

In some embodiments of the disclosure, the state space of the reinforcement learning and training environment includes an active power output of generating units, a reactive power output of the generating units, a voltage magnitude of the generating units, a load active power, a load reactive power, a load voltage magnitude, a charging and discharging power of an energy storage battery, a line status, a line loading rate, a power grid loss, a legal action space at a next time step, a startup-shutdown state of the generating units, a maximum active power output of renewable energy generating units at a current time step, a maximum active power output of the renewable energy generating units at a next time step, a load at a next time step and a power flow convergence flag.

In some embodiments of the disclosure, the state space also includes a reference value of a day-ahead planned active power output of the generating units.

In some embodiments of the disclosure, the reward feedback function is a weighted sum of a generation cost of the generating units, a carbon emission cost of the generating units, a loss cost of the energy storage battery, a reserve capacity usage cost, a line loading rate and a degree of node voltage exceeding the limit. Weight coefficients of the generation cost of the generating units, the carbon emission cost of the generating units, the loss cost of the energy storage battery, the reserve capacity usage cost and the degree of node voltage exceeding the limit are negative, and a weight coefficient of the line loading rate is positive.

All relevant contents of all operations involved in the embodiments of the aforementioned method for power grid real-time dispatch optimization can be referred to the functional descriptions of the corresponding functional modules in the system for the power grid real-time dispatch optimization in the embodiments of the disclosure, which will not be repeated here.

The division of modules in the embodiments of the disclosure is illustrative, and serves only as a logical functional division. In practice, there may be other divisions. In addition, functional modules in each embodiment of the disclosure may be integrated in one processor, may exist physically alone, or two or more functional modules may be integrated in one module. The integrated module described above can be realized in the form of hardware or in the form of software function module.

In yet another embodiment of the disclosure, there is provided a computer device. The computer device includes a processor and a memory for storing computer programs. The computer programs include program instructions, and the processor is configured for executing the program instructions stored in the computer storage medium. The processor may be a central processing unit (CPU), and may also be other general-purpose processors, digital signal processors (DSP), application-specific integrated circuits (ASICs), Field-Programmable Gate Arrays (FPGAs) or other programmable logic devices, discrete gates or transistor logic devices, discrete hardware components, etc. The processor is the computing core and control core of the terminal, and is suitable for implementing one or more instructions, specifically suitable for loading and executing one or more instructions in the computer storage medium to implement corresponding method flows or corresponding functions. The processor described in embodiments of the disclosure may be used for the operations of the method for power grid real-time dispatch optimization.

In yet another embodiment of the disclosure, the disclosure also provides a storage medium, specifically a computer readable storage medium (Memory), the computer readable storage medium being a memory device in a computer device, which is used for storing programs and data. It is appreciated that the computer readable storage medium herein may include both a built-in storage medium in the computer device and, of course, an extended storage medium supported by the computer device. The computer readable storage medium provides storage space that stores the operating system of the terminal. Further, one or more instructions suitable to be loaded and executed by the processor, which may be one or more computer programs (including program code), are stored in the memory space. It should be noted that the computer readable storage medium herein may be a high-speed RAM memory or a non-volatile memory, such as at least one disk memory. One or more instructions stored in a computer-readable storage medium may be loaded and executed by the processor to implement the corresponding operations with respect to the method for power grid real-time dispatch optimization in the above embodiments.

Those skilled in the art will appreciate that the embodiments of the disclosure may be provided as a method, a system or a computer program product. Therefore, the disclosure may take the form of an entirely hardware embodiment, an entirely software embodiment, or an embodiment combining both software and hardware aspects. Furthermore, the disclosure may take the form of a computer program product implemented on one or more computer-readable storage medium (including, but not limited to, disk storage, CD-ROM, optical memory, etc.) containing computer-executable program codes.

The disclosure is described with reference to flowcharts and/or block diagrams of methods, apparatus (systems) and computer program products according to the embodiments of the disclosure. It should be understood that each flow in the flowchart and/or each block in the block diagram, as well as combinations of the flows in the flowchart and/or the blocks in the block diagram, may be implemented by computer program instructions. These computer program instructions may be provided to a processor of a general purpose computer, a special purpose computer, an embedded processing machine, or other programmable data processing devices to produce a machine, such that instructions executed by the processor of the computer or other programmable data processing devices produce a device for implementing the functions specified in one or more flows in the flowchart and/or one or more blocks in the block diagram.

These computer program instructions may also be stored in a computer-readable memory capable of directing a computer or other programmable data processing device to operate in a specific manner, such that the instructions stored in the computer-readable memory produce an article of manufacture containing an instruction device for implementing the functions specified in one or more flows in the flowchart and/or one or more blocks in the block diagram.

These computer program instructions may also be loaded onto a computer or other programmable data processing device, such that a series of operating operations is performed on the computer or other programmable device to generate computer-implemented processing, thereby the instructions executed on the computer or other programmable device provide operations for implementing the functions specified in one or more flows in the flowchart and/or one or more blocks in the block diagram.

Finally, it should be noted that the above embodiments are intended only to illustrate and not limit the technical solutions of the disclosure, and while the disclosure has been described in detail with reference to the above embodiments, it should be understood by those of ordinary skill in the art that the specific embodiments of the disclosure may still be modified or equivalently substituted without departing from the spirit and scope of the disclosure. Any such modifications or equivalent substitutions should be encompassed within the scope of protection of the claims of the disclosure.

### INDUSTRIAL APPLICABILITY

In embodiments of the disclosure, by acquiring power grid model parameters and power grid operation data, and then using a preset reinforcement learning and training model for power grid real-time dispatch to optimize and adjust the power grid real-time dispatch, massive operation data of the power grid and power flow calculation simulation technologies can be fused by adopting reinforcement learning, without the need to establish a complex and difficult-to-solve computation model as a traditional algorithms, so that rapid optimization and adjustment for power grid real-time dispatch can be achieved, the optimization and adjustment cost can be reduced, and the matching degree between power grid real-time dispatch adjustment strategy and actual operation can be improved effectively. It effectively solves the problems in power grid real-time dispatch optimization that due to strong uncertainty and rapidly growing of control scale and the like of new power systems, existing algorithms face difficulties in modeling in consideration of uncertain factors and slow computation for solving large-scale optimization.

1. A method for power grid real-time dispatch optimization, the method comprising:
acquiring power grid model parameters and power grid operation data;
obtaining, according to the power grid model parameters and the power grid operation data, a power grid real-time dispatch adjustment strategy through a preset reinforcement learning and training model for power grid real-time dispatch;
wherein the preset reinforcement learning and training model for the power grid real-time dispatch comprises an agent and a reinforcement learning and training environment;
wherein the obtaining the power grid real-time dispatch adjustment strategy through the preset reinforcement learning and training model for the power grid real-time dispatch, comprises:
repeating interaction operations for a preset number of times; wherein the interaction operations comprise that: the reinforcement learning and training environment obtains a state space through a preset power flow simulation function according to the power grid model parameters and the power grid operation data, obtains a reward feedback through a preset reward feedback function according to the state space, and transmits the state space and the reward feedback to the agent; the agent obtains an action strategy according to the state space and the reward feedback and transmits the action strategy to the reinforcement learning and training environment; and the reinforcement learning and training environment verifies the action strategy according to an action space, and updates the power grid operation data by executing the verified action strategy; and
taking the action strategy executed when the reward feedback is the highest as the power grid real-time dispatch adjustment strategy;
wherein the state space of the reinforcement learning and training environment comprises an active power output of generating units, a reactive power output of the generating units, a voltage magnitude of the generating units, a load active power, a load reactive power, a load voltage magnitude, a charging and discharging power of an energy storage battery, a line status, a line loading rate, a power grid loss, a legal action space at a next time step, a startup-shutdown state of the generating units, a maximum active power output of renewable energy generating units at a current time step, a maximum active power output of the renewable energy generating units at a next time step, a load at a next time step and a power flow convergence flag; and
wherein the reward feedback function is a weighted sum of a generation cost of the generating units, a carbon emission cost of the generating units, a loss cost of the energy storage battery, a reserve capacity usage cost, a line loading rate and a degree of node voltage exceeding the limit; wherein weight coefficients of the generation cost of the generating units, the carbon emission cost of the generating units, the loss cost of the energy storage battery, the reserve capacity usage cost and the degree of node voltage exceeding the limit are negative, and a weight coefficient of the line loading rate is positive.

2. The method for power grid real-time dispatch optimization of claim 1, wherein the method further comprises:
acquiring equipment failure information of a power grid, and updating the power grid model parameters according to the equipment failure information.

3. The method for power grid real-time dispatch optimization of claim 1, wherein the action space comprises respective action variables and action constraints of thermal power units, PV-type renewable energy generating units, PQ-type renewable energy generating units and an energy storage battery; wherein the action variable of the thermal power units comprises an active power adjustment amount and a terminal voltage adjustment amount; the action variable of the PV-type renewable energy generating units comprises an active power adjustment amount and a terminal voltage adjustment amount; the action variable of the PQ-type renewable energy generating units comprises an active power adjustment amount and a reactive power adjustment amount; the action variable of the energy storage battery comprises an active power adjustment amount; the action constraint of the thermal power units comprises a power output constraint of the generating units, a power output ramping constraint of the generating units, a terminal voltage constraint of the thermal power units and a startup-shutdown constraint of the generating units; the action constraint of the PV-type renewable energy generating units comprises a terminal voltage constraint of the renewable energy generating units and a maximum allowable power output constraint of PV-type renewable energy; the action constraint of the PQ-type renewable energy generating units comprises a maximum allowable power output constraint of PQ-type renewable energy and a reactive power constraint of the generating units; the action constraint of the energy storage battery comprises a battery charging and discharging constraint and a battery capacity constraint.

4. The method for power grid real-time dispatch optimization of claim 1, wherein the state space further comprises a reference value of a day-ahead planned active power output of the generating units.

5. A system for power grid real-time dispatch optimization, the system comprising:
a processor; and
a memory configured to store an instruction executable on the processor,
wherein the processor is configured to:
acquire power grid model parameters and power grid operation data; and
obtain a power grid real-time dispatch adjustment strategy through a preset reinforcement learning and training model for power grid real-time dispatch according to the power grid model parameters and the power grid operation data;
wherein the preset reinforcement learning and training model for the power grid real-time dispatch comprises an agent and a reinforcement learning and training environment;
wherein the processor is further configured to repeat interaction operations for a preset number of times; wherein the interaction operations comprise that: the reinforcement learning and training environment obtains a state space through a preset power flow simulation function according to the power grid model parameters and the power grid operation data, obtains a reward feedback through a preset reward feedback function according to the state space, and transmits the state space and the reward feedback to the agent; the agent obtains an action strategy according to the state space and the reward feedback and transmits the action strategy to the reinforcement learning and training environment; and the reinforcement learning and training environment verifies the action strategy according to an action space, and updates the power grid operation data by executing the verified action strategy; and taking the action strategy executed when the reward feedback is the highest as the power grid real-time dispatch adjustment strategy;
wherein the state space of the reinforcement learning and training environment comprises an active power output of generating units, a reactive power output of the generating units, a voltage magnitude of the generating units, a load active power, a load reactive power, a load voltage magnitude, a charging and discharging power of an energy storage battery, a line status, a line loading rate, a power grid loss, a legal action space at a next time step, a startup-shutdown state of the generating units, a maximum active power output of renewable energy generating units at a current time step, a maximum active power output of the renewable energy generating units at a next time step, a load at a next time step and a power flow convergence flag; and
wherein the reward feedback function is a weighted sum of a generation cost of the generating units, a carbon emission cost of the generating units, a loss cost of the energy storage battery, a reserve capacity usage cost, a line loading rate and a degree of node voltage exceeding the limit; wherein weight coefficients of the generation cost of the generating units, the carbon emission cost of the generating units, the loss cost of the energy storage battery, the reserve capacity usage cost and the degree of node voltage exceeding the limit are negative, and a weight coefficient of the line loading rate is positive.

6. The system for power grid real-time dispatch optimization of claim 5, wherein the processor is further configured to: acquire equipment failure information of a power grid, and updating the power grid model parameters according to the equipment failure information.

7. The system for power grid real-time dispatch optimization of claim 5, wherein the action space comprises respective action variables and action constraints of thermal power units, PV-type renewable energy generating units, PQ-type renewable energy generating units and an energy storage battery; wherein the action variable of the thermal power units comprises an active power adjustment amount and a terminal voltage adjustment amount; the action variable of the PV-type renewable energy generating units comprises an active power adjustment amount and a terminal voltage adjustment amount; the action variable of the PQ-type renewable energy generating units comprises an active power adjustment amount and a reactive power adjustment amount; the action variable of the energy storage battery comprises an active power adjustment amount; the action constraint of the thermal power units comprises a power output constraint of the generating units, a power output ramping constraint of the generating units, a terminal voltage constraint of the thermal power units and a startup-shutdown constraint of the generating units; the action constraint of the PV-type renewable energy generating units comprises a terminal voltage constraint of the renewable energy generating units and a maximum allowable power output constraint of PV-type renewable energy; the action constraint of the PQ-type renewable energy generating units comprises a maximum allowable power output constraint of PQ-type renewable energy and a reactive power constraint of the generating units; the action constraint of the energy storage battery comprises a battery charging and discharging constraint and a battery capacity constraint.

8. The system for power grid real-time dispatch optimization of claim 5, wherein the state space further comprises a reference value of a day-ahead planned active power output of the generating units.

9. (canceled)

10. A non-transitory computer-readable storage medium, storing computer programs that when executed by a processor, implement a method for power grid real-time dispatch optimization, wherein the method comprises:
acquiring power grid model parameters and power grid operation data;
obtaining, according to the power grid model parameters and the power grid operation data, a power grid real-time dispatch adjustment strategy through a preset reinforcement learning and training model for power grid real-time dispatch;
wherein the preset reinforcement learning and training model for the power grid real-time dispatch comprises an agent and a reinforcement learning and training environment;
wherein the obtaining the power grid real-time dispatch adjustment strategy through the preset reinforcement learning and training model for the power grid real-time dispatch, comprises:
repeating interaction operations for a preset number of times; wherein the interaction operations comprise that: the reinforcement learning and training environment obtains a state space through a preset power flow simulation function according to the power grid model parameters and the power grid operation data, obtains a reward feedback through a preset reward feedback function according to the state space, and transmits the state space and the reward feedback to the agent; the agent obtains an action strategy according to the state space and the reward feedback and transmits the action strategy to the reinforcement learning and training environment; and the reinforcement learning and training environment verifies the action strategy according to an action space, and updates the power grid operation data by executing the verified action strategy; and
taking the action strategy executed when the reward feedback is the highest as the power grid real-time dispatch adjustment strategy;
wherein the state space of the reinforcement learning and training environment comprises an active power output of generating units, a reactive power output of the generating units, a voltage magnitude of the generating units, a load active power, a load reactive power, a load voltage magnitude, a charging and discharging power of an energy storage battery, a line status, a line loading rate, a power grid loss, a legal action space at a next time step, a startup-shutdown state of the generating units, a maximum active power output of renewable energy generating units at a current time step, a maximum active power output of the renewable energy generating units at a next time step, a load at a next time step and a power flow convergence flag; and
wherein the reward feedback function is a weighted sum of a generation cost of the generating units, a carbon emission cost of the generating units, a loss cost of the energy storage battery, a reserve capacity usage cost, a line loading rate and a degree of node voltage exceeding the limit; wherein weight coefficients of the generation cost of the generating units, the carbon emission cost of the generating units, the loss cost of the energy storage battery, the reserve capacity usage cost and the degree of node voltage exceeding the limit are negative, and a weight coefficient of the line loading rate is positive.

11. The non-transitory computer-readable storage medium of claim 10, wherein the method further comprises:
acquiring equipment failure information of a power grid, and updating the power grid model parameters according to the equipment failure information.

12. The non-transitory computer-readable storage medium of claim 10, wherein the action space comprises respective action variables and action constraints of thermal power units, PV-type renewable energy generating units, PQ-type renewable energy generating units and an energy storage battery; wherein the action variable of the thermal power units comprises an active power adjustment amount and a terminal voltage adjustment amount; the action variable of the PV-type renewable energy generating units comprises an active power adjustment amount and a terminal voltage adjustment amount; the action variable of the PQ-type renewable energy generating units comprises an active power adjustment amount and a reactive power adjustment amount; the action variable of the energy storage battery comprises an active power adjustment amount; the action constraint of the thermal power units comprises a power output constraint of the generating units, a power output ramping constraint of the generating units, a terminal voltage constraint of the thermal power units and a startup-shutdown constraint of the generating units; the action constraint of the PV-type renewable energy generating units comprises a terminal voltage constraint of the renewable energy generating units and a maximum allowable power output constraint of PV-type renewable energy; the action constraint of the PQ-type renewable energy generating units comprises a maximum allowable power output constraint of PQ-type renewable energy and a reactive power constraint of the generating units; the action constraint of the energy storage battery comprises a battery charging and discharging constraint and a battery capacity constraint.

13. The non-transitory computer-readable storage medium of claim 10, wherein the state space further comprises a reference value of a day-ahead planned active power output of the generating units.
